(19) United States
(12) Patent Application Publication
(10) Pub. No.: US 2015/0357611 A1
(43) Pub. Date: Dec. 10, 2015

(54) BATTERY CASE AND ELECTRODE PLATE SET FOR USE IN THE SAME

(71) Applicant: Dah-Luen Huang, New Taipei City (TW)

(72) Inventor: Li-Zhen ZHOU, New Taipei City (TW)

(21) Appl. No.: 14/475,915

(22) Filed: Sep. 3, 2014

(30) Foreign Application Priority Data
Jun. 5, 2014 (TW) 103209947

(51) Int. Cl. H01M 2/10

(52) U.S. Cl. CPC H01M 2/1055

(57) ABSTRACT

The present invention relates to a battery case, which includes: a case body, composed of a bottom wall, two lateral walls, a front wall and a rear wall thereby allowing an elongated accommodation space to be formed, and the accommodation space is formed with at least two insertion slots according to the circuit layout; and an electrode plate set, including a cathode connection plate and an anode connection plate, the cathode and the anode connection plates are respectively inserted in the corresponding insertion slots according to the circuit layout; wherein each of the connection plates is adjacently formed with a pair of first clamping members and a pair of second clamping members thereby enabling a metal wire member and an insulation jacket of a conductive wire to be respectively clamped for providing a dual clamping function, and the conductive wires are protruded out from the case body.

### BACKGROUND OF THE INVENTION

1. Field of the Invention

The present invention relates to a battery case, especially to a battery case having an advantage of effectively prolonging its service life. Moreover, the present invention further includes an electrode plate set for use in battery case

2. Description of Related Art:

A dry battery has been invented and widely applied for many years. The dry battery allows electric power to be stored in a columnar body and to be supplied when necessary. Unlike the conventional power source which is fixed in a certain location, one feature of the dry battery is portable, thereby providing more convenience for the user to operate an electronic product.

As such, a device for accommodating batteries is developed, and the accommodation and storage of batteries are sometimes combined with the electronic product, such as an electricity-driven toy, a hand-held radio set or a flashlight. But sometimes, the device for accommodating batteries, i.e. a battery case, is separately installed relative to the electronic product and at least a conductive wire is required for connecting the two.

One feature of the above-mentioned battery case is that most of the circuits are connected in series; take a conventional battery case for example, two batteries are adjacently disposed therein for forming as a pair, and a case body of the conventional battery case is provided with an electrode plate set which includes at least a cathode connection plate and at least an anode connection plate, and the anode and the cathode connection plates are respectively connected to a conductive wire protruded out from the case body, the batteries are accommodated and positioned in a chamber formed inside the case body, and the anode and the cathode connection plates are electrically connected.

The connection of the anode and the cathode connection plates and the conductive wires is mostly established by a soldering means, in other word a metal wire member of the conductive wire is respectively soldered on the anode connection plate and the cathode connection plate. In addition, a through hole is respectively formed on the anode and the cathode connection plates corresponding to the soldering location thereby allowing the soldering tin to flow into the through hole so as to be solidified therein for enhancing the combination strength formed between the soldering tin and the anode and the cathode connection plates. However, the soldering operation for the anode and the cathode connection plates and the conductive wires is mostly done by a manual force, and the soldering tin may be oxidized thereby causing the soldering tin to be released from the anode and the cathode connection plates and causing the battery case unable to supply the electric power. In addition, the metal wire member of the conductive wire is soldered on the anode and the cathode connection plates; when being installed in the battery case, the conductive wire may be pulled or twisted so the conductive wire may be broken.

### SUMMARY OF THE INVENTION

One primary objective of the present invention is to provide a battery case, which includes a case body and an electrode plate set, an cathode and an anode connection plates of the electrode plate set and conductive wires are connected with a clamping means thereby overcoming the disadvantages of the soldering tin between the anode and the cathode connection plates and the conductive wires to be released due to oxidation and a metal wire member of the conductive wire being broken because of being bent or twisted, so the service life of the battery case can be effectively prolonged.

For achieving aforesaid objective, one technical solution of the present invention is to provide a battery case, which includes: a case body, composed of a bottom wall, two lateral walls, a front wall and a rear wall thereby allowing an elongated accommodation space to be formed, and the interior of the accommodation space is formed with at least two insertion slots according to the circuit layout; and an electrode plate set, including a cathode connection plate and an anode connection plate, the cathode and the anode connection plates are respectively inserted in the corresponding insertion slots according to the circuit layout; wherein each of the connection plates is adjacently formed with a pair of first clamping members and a pair of second clamping members thereby enabling a metal wire member and an insulation jacket of a conductive wire to be respectively clamped for providing a dual clamping function, and the conductive wires are protruded out from the case body.

Another objective of the present invention is to provide an electrode plate set for use in battery case, which includes an anode connection plate and a cathode connection plate, the anode and the cathode connection plates and conductive wires are respectively connected by a clamping means thereby overcoming the disadvantages of the soldering tin between the anode and the cathode connection plates and the conductive wires to be released due to oxidation and a metal wire member of the conductive wire being broken because of being bent or twisted.

For achieving aforesaid objective, one technical solution of the present invention is to provide an electrode plate set for use in battery case, which includes a cathode connection plate and an anode connection plate, wherein each of the connection plates is adjacently formed with a pair of first clamping members and a pair of second clamping members thereby enabling a metal wire member and an insulation jacket of a conductive wire to be respectively clamped for providing a dual clamping function.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view illustrating the battery case according to the present invention;

FIG. 2a and FIG. 2b are perspective exploded views illustrating the cathode connection plate of the electrode plate set and the conductive wire being viewed from different angles according to the present invention;

FIG. 3 is a perspective view illustrating the conductive wire being clamped by the cathode connection plate of the electrode plate set according to the present invention;

FIG. 4a and FIG. 4b are perspective exploded views illustrating the anode connection plate of the electrode plate set and the conductive wire being viewed from different angles according to the present invention;

FIG. 5 is a perspective view illustrating the conductive wire being clamped by the anode connection plate of the electrode plate set according to the present invention; and

FIG. 6 is a perspective view illustrating the assembly of the battery case according to the present invention.

### DETAILED DESCRIPTION OF THE PREFERRED EMBODIMENT

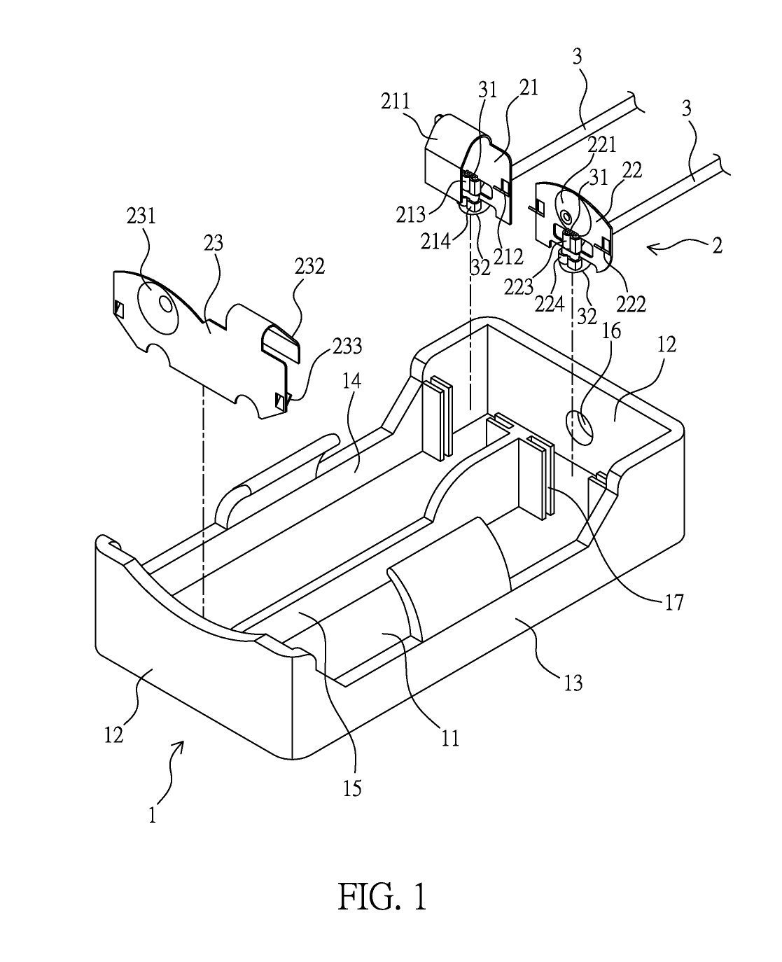

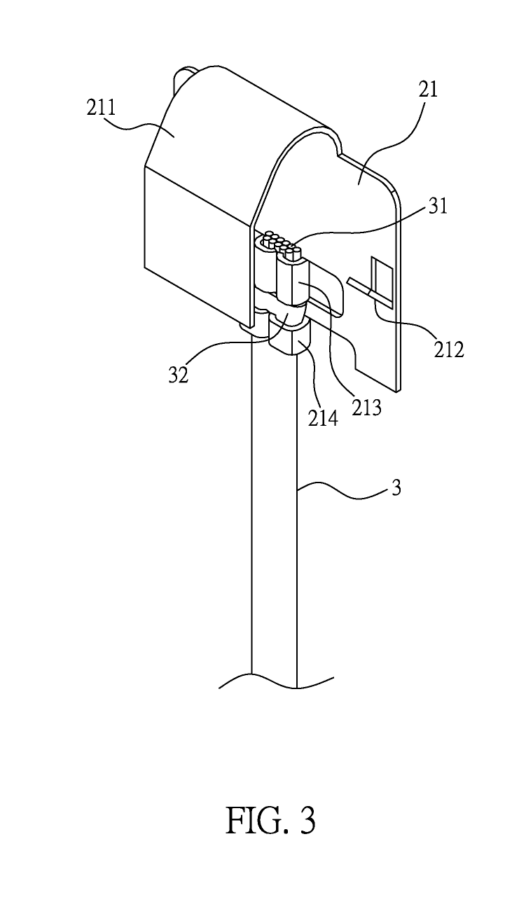

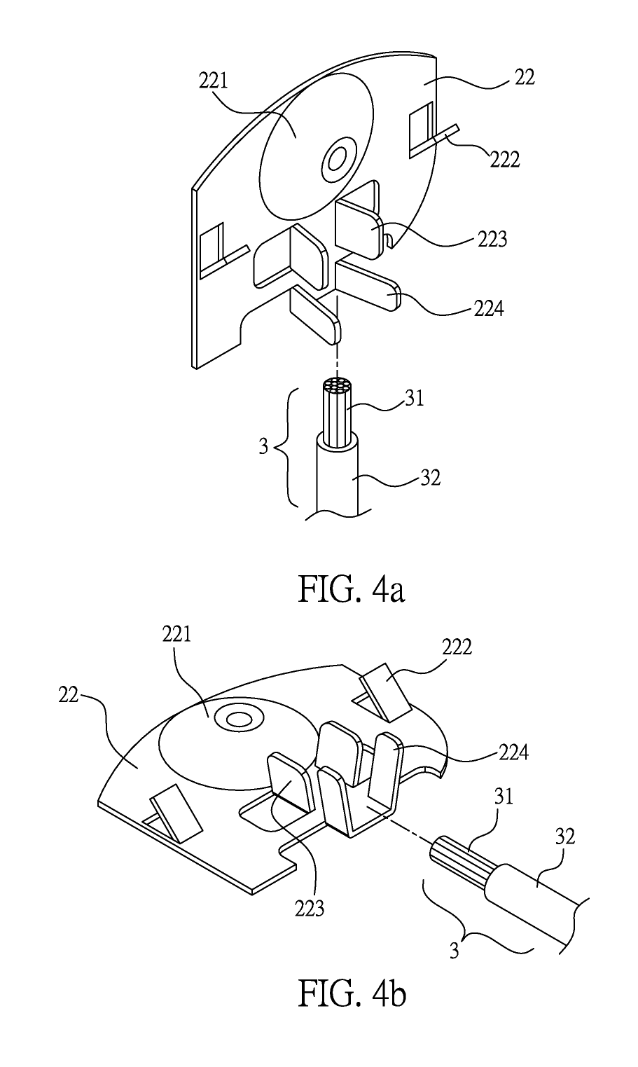

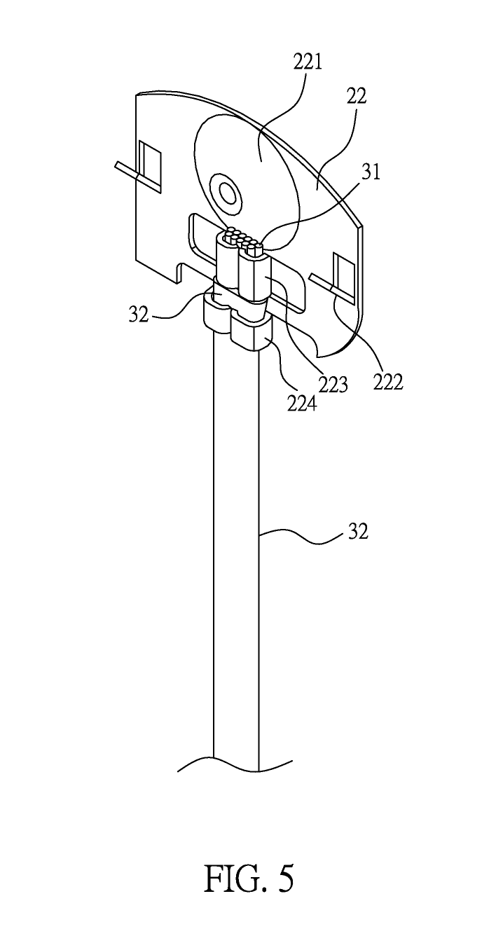

Referring from FIG. 1 to FIG. 6, the present invention provides a battery case, which includes a case body 1, an electrode plate set 2 and two conductive wires 3.

The case body 1 is formed as a semi-sealed elongated case member, and two sides of a bottom wall 11 thereof are respectively and vertically formed with a lateral wall 12, and the edge of each of the lateral walls 12 is respectively and transversally formed with a front wall 13 and a rear wall 14, thereby forming an elongated accommodation space for allowing at least a battery to be accommodated and positioned, what shall be addressed is that the above-mentioned is well known prior art, therefore no further illustration is provided. In addition, for separating two adjacent batteries, at least a separation rib 15 is transversally formed between the two lateral walls 12. Moreover, one of the lateral walls 12 is formed with at least a wire hole 16 allowing the conductive wires 3 connected to the electrode plate set 2 to be protruded out. Furthermore, the interior of the case body 1 is formed with at least two insertion slots 17 corresponding to the electrode plate set 2, thereby allowing each connection plate, e.g. a cathode connection plate 21, an anode connection plate 22 and an intermediate connection plate 23, to be inserted and positioned.

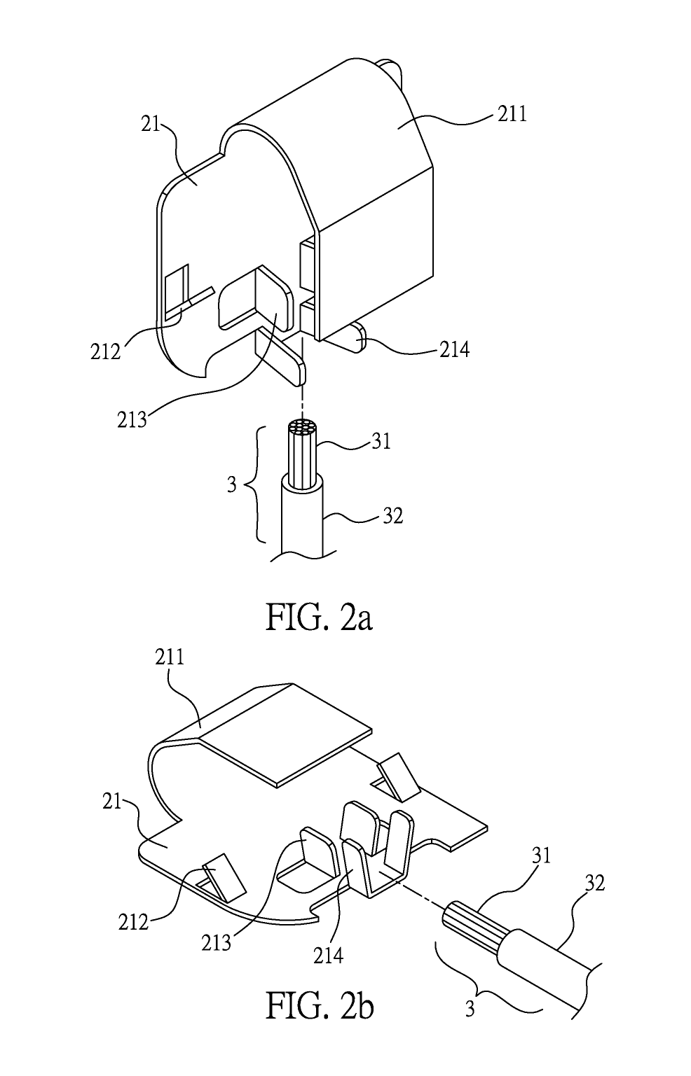

As shown from FIG. 2b to FIG. 5, the electrode plate set 2 is composed of a cathode connection plate 21 and an anode connection plate 22; as shown in FIG. 1, two batteries are adjacently disposed in the battery case, what shall be addressed is that the scope of the present invention is not limited to the above-mentioned arrangement, two or more batteries can be adjacently disposed in the battery case according to the actual power supplying requirement; and for allowing circuits to be connected in series, the inner surface of one of the lateral walls 12 of the battery case is respectively inserted with a cathode connection plate 21 and an anode connection plate 22, and the other lateral wall 12 is correspondingly inserted with at least one intermediate connection plate 23 formed with a anode connection point 231 and/or a cathode connection point 232 thereby forming a circuit connection, and after the cathode and the anode connection plates 21, 22 are respectively connected to the corresponding conductive wires 3, the conductive wires 3 are protruded out from the wire hole 16 of the lateral wall 12, what shall be addressed is that the arrangement of the anode and the cathode connection plates of the electrode plate set 2 being connected in series or in parallel is known as prior art and shall be determined according to the customer's requirement, thereof no further illustration is provided.

The cathode and the anode connection plates 21, 22 are formed with a continuous punching means and respectively formed with a cathode elastic piece 211 and an anode convex part 221, and two sides of each of the connection plates 21, 22, 23 are respectively formed with a pair of obliquely-protruded abutting tenons 212, 222, 233, when the connection plates 21, 22, 23 are inserted in the insertion slots 17 preformed in the case body 1, each pair of abutting tenons 212, 222, 233 of the connection plates 21, 22, 23 are compressed and deformed in each of the insertion slots 17 so as to form an abutting status, thereby allowing the connection plates 21, 22, 23 to be stably inserted in the corresponding insertion slots 17.

The technical feature of the cathode and the anode connection plates 21, 22 is that: the cathode and the anode connection plates 21, 22 are respectively and adjacently formed with a pair of first clamping members 213, 223 and a pair of second clamping members 214, 224 thereby enabling a metal wire member 31 and an insulation jacket 32 of each of the conductive wires 3 to be respectively clamped for providing a dual firmly clamping function. Wherein, when the two pairs of clamping members of each of the connection plates are in use, the width of the pair of first clamping members 213, 223 is wider than that of the pair of second clamping members 214, 224, and the height of the pair of second clamping members 214, 224 is higher than that of the pair of first clamping members 213, 223.

Because the metal wire member 31 of each of the conductive wires 3 is clamped by the pair of first clamping members 213, 223 of the cathode and the anode connection plates 21, 22, the disadvantages of the soldered tin being released due to oxidation or poor soldering can be overcome; and the insulation jacket 32 of each of the conductive wires 3 is clamped by the pair of second clamping members 214, 224 of the cathode and the anode connection plates 21, 22, so the bending or twisting location is able to be formed on the insulation jacket 32, thereby overcoming the disadvantage of the metal wire member 31 being easily broken.

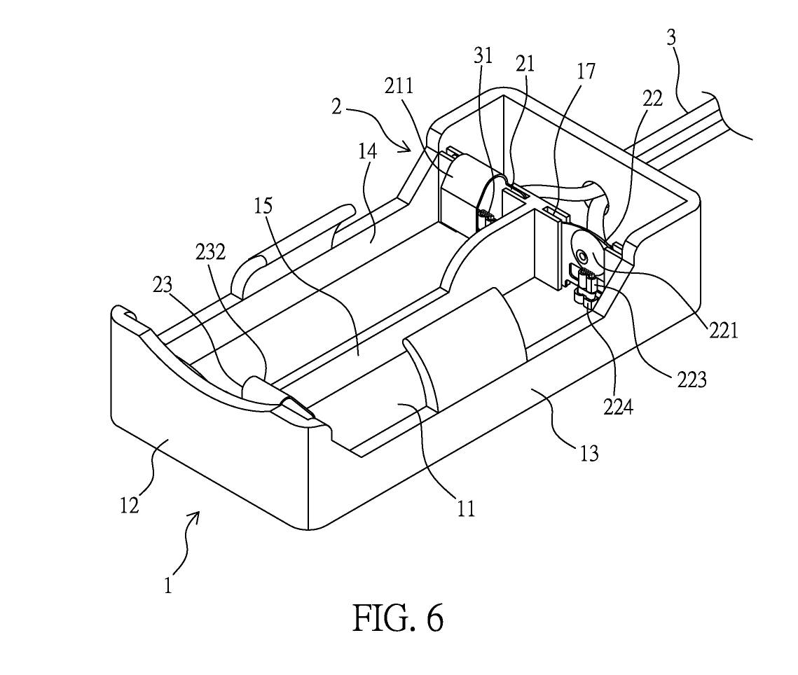

As shown in FIG. 6, the components shown in FIG. 1, such as the case body 1, the cathode and the anode connection plates 21, 22 of the electrode plate set 2 and the intermediate connection plate 23, are disposed and positioned, and the two conductive wires 3 respectively clamped on the cathode and the anode connection plates 21, 22 are protruded out from the wire hole 16, the assembly of the battery case is finished.

Based on what has been disclosed above, advantages achieved by the present invention are as followings: the metal wire member and the insulation jacket of each of the conductive wires are respectively clamped by the pair of first clamping members and the pair of second clamping members of the cathode and the anode connection plates, so the disadvantages of soldered tin being released due to oxidation, poor soldering and the metal wire member being easily broken can be overcome, so the service life of the battery case is able to be effectively prolonged. Accordingly, the battery case provided by the present invention is novel and more practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A battery case, including:
a case body, composed of a bottom wall, two lateral walls, a front wall and a rear wall thereby allowing an elongated accommodation space to be formed, and the interior of said accommodation space being formed with at least two insertion slots according to a circuit layout; and
an electrode plate set, including a cathode connection plate and an anode connection plate, said cathode and said anode connection plates being respectively inserted in said corresponding insertion slots according to said circuit layout; wherein each of said connection plates being adjacently formed with a pair of first clamping members and a pair of second clamping members thereby enabling a metal wire member and an insulation jacket of a conductive wire to be respectively clamped for providing a dual clamping function, and said conductive wires being protruded out from said case body.

2. The battery case as claimed in claim 1, wherein at least a separation rib is transversally formed between said two lateral walls for separating two adjacent batteries; and one of said lateral walls is formed with at least a wire hole allowing said conductive wires to be protruded out.

3. The battery case as claimed in claim 1, further including at least one intermediate connection plate formed with an anode connection point and/or a cathode connection point, and each of said intermediate connection plates is inserted in said corresponding insertion slot according to said circuit layout.

4. The battery case as claimed in claim 1, wherein said cathode and said anode connection plates are respectively formed with a cathode elastic piece and an anode convex part, and two sides of said cathode and said anode connection plates are respectively formed with a pair of obliquely-protruded abutting tenons inserted in said insertion slots.

5. The battery case as claimed in claim 3, wherein two sides of each of said intermediate connection plates are respectively formed with a pair of obliquely-protruded abutting tenons inserted in said insertion slots.

6. The battery case as claimed in claim 1, wherein the width of said pair of first clamping members is wider than that of said pair of second clamping members of said cathode and said anode connection plates.

7. The battery case as claimed in claim 6, wherein the height of said pair of second clamping members is higher than that of said pair of first clamping members of said cathode and said anode connection plates.

8. An electrode plate set for use in battery case, including an anode connection plate and a cathode connection plate, wherein each of said connection plates being adjacently formed with a pair of first clamping members and a pair of second clamping members thereby enabling a metal wire member and an insulation jacket of a conductive wire to be respectively clamped for providing a dual clamping function.

9. The electrode plate set for use in battery case as claimed in claim 8, wherein said cathode and said anode connection plates are respectively formed with a cathode elastic piece and an anode convex part, and two sides of said cathode and said anode connection plates are respectively formed with a pair of obliquely-protruded abutting tenons.

10. The electrode plate set for use in battery case as claimed in claim 8, wherein the width of said pair of first clamping members is wider than that of said pair of second clamping members of said cathode and said anode connection plates.

11. The electrode plate set for use in battery case as claimed in claim 10, wherein the height of said pair of second clamping members is higher than that of said pair of first clamping members of said cathode and said anode connection plates.
